(19) United States
(12) Patent Application Publication
(10) Pub. No.: US 2023/0067840 A1
(43) Pub. Date: Mar. 2, 2023

(54) FLAME RESISTANT NON-NEWTONIAN PAD

(71) Applicant: Fire-Dex, LLC, Medina, OH (US)

(72) Inventor: Matthew L. Colatruglio, Medina, OH (US)

(21) Appl. No.: 17/929,221

(22) Filed: Sep. 1, 2022

Related U.S. Application Data
(60) Provisional application No. 63/239,448, filed on Sep. 1, 2021.

(51) Int. Cl. B32B 5/26; B32B 7/022; B32B 7/08; B32B 5/18

(52) U.S. Cl. CPC B32B 5/26; B32B 5/18; B32B 7/08; B32B 7/022; A62B 17/003

(57) ABSTRACT

A pad for protective garments comprises an outer layer of heat and flame resistant material, and inner layer of heat and flame resistant material, and a cushioning layer disposed therebetween. The cushioning layer is produced from a non-newtonian material. A pad assembly may be formed using the pad along with a piece of flexible material attached thereto. The pad, or the pad assembly including the pad, may be used with protective garments such as firefighter turnout gear.

### CROSS REFERENCE TO RELATED APPLICATION

This application claims the benefit of U.S. Provisional Pat. Application Serial No. 63/239,448, filed Sep. 1, 2021, the entirety of which is herein incorporated by reference.

### FIELD

The present disclosure relates to firefighting equipment and, more specifically, to firefighting equipment having a flame resistant material and enhanced thermal properties.

### BACKGROUND

Conventional firefighting turnout gear includes coats, pants, coveralls, helmets, gloves, footwear, and interface components. Typically, the coats and pants each comprises an outer shell, a moisture barrier located within the outer shell, a thermal liner located within the moisture barrier and an innermost face cloth layer. The outer shell typically is constructed of an abrasion-, flame- and heat-resistant material such as a woven aramid material, typically NOMEX® or KEVLAR(R) (all are trademarks of E. I. DuPont de Nemours & Co., Inc.) or a polybenzamidazole such a PBI® (a trademark of Celanese Corp.) fiber material. The moisture barrier typically includes a semipermeable membrane layer which is moisture vapor permeable but impermeable to liquid moisture, such as CROSSTECH® (a trademark of W. L. Gore & Associates, Inc.). The membrane layer is bonded to a substrate of flame- and heat-resistant material, such as an aramid or PBI® material.

It is often desirable to provide padding to the knee portions of firefighting pants, or to the elbow/forearm or shoulder areas of firefighting turnout coats to provide extra cushioning against compression or protection from heat for the firefighter’s knees, elbows, forearms and/or shoulders. Such cushioning is particularly useful when a firefighter is kneeling or crawling, or is carrying equipment such as a ladder, a hose line or SCBA equipment, and is also useful to absorb blows and other shocks that may be encountered in hazardous duty situations. In such situations the weight of a firefighter, or the weight of the equipment, is concentrated in a small area, which compresses the thermal liner in that area and thereby significantly reduces its insulating ability.

A drawback of conventional pads for use with firefighting garments is that they are bulky and cumbersome due to being constructed of foam and thick nonwoven fabrics. Such construction impedes a performance of the firefighter because the bulky conventional pads make it difficult for the firefighter’s pants to fit around his/her boots, which inhibits the donning and doffing of the firefighter’s pants. Another problem with the conventional pads for use with firefighting garments is that a relatively low-cost pad that is relatively simple to attach to a firefighting garment and that meets the National Fire Protection Association (NFPA) 1971 standard, incorporated herein by reference, (which require substantial heat- and flame-resistance as well as specified tear strength) is not available. There is also a problem with many conventional knee- and/or elbow-pads in that they provide relatively little thermal and impact protection to the knees and/or elbow portions of the garment when compressed. Accordingly, such conventional elbow-, shoulder- and/or knee-pads do little to prevent burns in the knees, shoulders and/or elbows of firefighters resulting from the loss of insulating ability caused by compression of the garment in those areas. For those conventional elbow-, shoulder- or knee-pads that do provide additional thermal protection, there exists a problem of such thermal protection breaking down over time due to damage, compression and/or abrasions to the pads or such numerous layers of material required that the pads are extremely bulky and cumbersome and easily mispositioned. Foam and silicone materials used for conventional elbow-, shoulder- and/or knee-pads can become deformed after time losing thickness and shape and providing less protection. A further problem with conventional elbow-, shoulder- and/or knee-pads is their tendency to absorb water or otherwise retain substantial quantities of water. Saturated pads, when exposed to thermal energy conduct that heat at far greater rates than insulation which does not store water

Accordingly, it would be desirable to provide a pad for firefighting equipment that provides thermal and impact protection with enhanced durability and abrasion resistance.

### SUMMARY

In concordance and agreement with the presently described subject matter, a pad for firefighting equipment that provides thermal and impact protection with enhanced durability and abrasion resistance, has surprisingly been discovered.

In one embodiment, a pad, comprises: a first layer produced from a heat and flame resistant material; a second layer disposed on the first layer, wherein the second layer is produced from a non-newtonian material.

As aspects of some embodiments, the heat and flame resistant material of the first layer is a fabric material.

As aspects of some embodiments, the non-newtonian material is a foam material.

As aspects of some embodiments, the second layer includes one or more cushioning regions formed by at least one channel.

As aspects of some embodiments, the pad further comprises a third layer produced from a heat and flame resistant material.

As aspects of some embodiments, the pad further comprises a flange provided around a peripheral edge of the pad.

As aspects of some embodiments, the first layer includes a surface treatment for increasing a durability, abrasion resistance, and/or friction of the pad.

As aspects of some embodiments, the surface treatment is a coating deposited on the first layer.

As aspects of some embodiments, the coating is a chlorosulfonated polyethylene material.

As aspects of some embodiments, the surface treatment is one or more surface irregularities formed on a surface of the first layer.

As aspects of some embodiments, the one or more surface irregularities is produced from a durable, heat and flame resistant material.

In another embodiment, a pad assembly, comprises: a piece of flexible material; and a pad coupled to the piece of flexible material, wherein the pad comprises a first layer and a second layer disposed on the first layer, wherein the second layer is produced from a non-newtonian material.

As aspects of some embodiments, wherein the pad further comprises a third layer coupled to the second layer.

As aspects of some embodiments, at least one of the first layer and the third layer is produced from a heat and flame resistant material.

As aspects of some embodiments, the pad further comprises at least one protective layer disposed between the second layer and at least one of the first layer and the third layer.

In yet another embodiment, a method of producing a pad for firefighting equipment, comprising the steps of: providing a first layer of a heat and flame resistant material; providing a second layer of non-newtonian foam material; and coupling the second layer to the first layer.

As aspects of some embodiments, the method further comprises providing a third layer produced from a heat and flame resistant material.

As aspects of some embodiments, the method further comprises coupling the third layer to the second layer to form the pad.

As aspects of some embodiments, the method further comprises applying a coating to the first layer.

As aspects of some embodiments, the coating is uncured until the second layer is coupled to the first layer.

### BRIEF DESCRIPTION OF THE DRAWINGS

The above, as well as other advantages of the present disclosure, will become readily apparent to those skilled in the art from the following detailed description of a preferred embodiment when considered in the light of the accompanying drawings.

FIG. 1 is a rear perspective view of a pad according to an embodiment of the present disclosure;

FIG. 2 is a rear elevational view of the pad of FIG. 1;

FIG. 3 is a right side elevational view of the pad of FIGS. 1 and 2 having a portion of the pad shown in section;

FIG. 4 is a front elevational view of a pad according to another embodiment of the present disclosure;

FIG. 5 is a left side elevational view of the pad of FIG. 4 having a perimeter flange removed and a portion shown in section;

FIG. 6 is a bottom plan view of the pad of FIGS. 4 and 5 having the perimeter flange removed;

FIG. 7 is a front elevational view of a pad according to another embodiment of the present disclosure, wherein the pad includes a surface treatment comprising one or more surface irregularities;

FIGS. 8A-8F illustrate various types of surface irregularities that may be used with, or as alternatives to, the surface irregularities shown within the circled area of FIG. 7;

FIG. 9 is a side perspective view of a pad assembly according to an embodiment of the present disclosure, wherein the pad assembly includes a pad attached to a piece of flexible material;

FIG. 10 is a front elevational view of a protective garment provided with a pad assembly including a pad and the piece of flexible material in accordance with the present disclosure; and

FIG. 11 is a rear elevational view of the protective garment of FIG. 10.

### DETAILED DESCRIPTION

The following detailed description and appended drawings describe and illustrate various exemplary embodiments of the present disclosure. The description and drawings serve to enable one skilled in the art to make and use the present disclosure, and are not intended to limit the scope of the present disclosure in any manner. In respect of the methods disclosed, the steps presented are exemplary in nature, and thus, the order of the steps is not necessary or critical.

It has been found that the pads of the present disclosure including the layer of the non-newtonian material and/or surface treatments provide enhanced thermal and impact protection and/or high resistance to tear, abrasion and flame (i.e. minimizes char, melt or susceptibility to combustion). The pads of the present disclosure may provide 2x-3x the abrasion and flame resistance of conventional pads. The pads also resist thermal conductivity while providing sufficient cushioning to the user. In comparison to conventional pads, the single-piece construction of the pads of the present disclosure minimizes complexity of repair and/or replacement thereof.

The present pads include cushioning regions of various shapes, sizes, configurations and thicknesses. Various materials can be used for the cushioning regions, as will be described below. In some embodiments, the cushioning regions are spaced apart by channels of various depths and configurations, which define the perimeter of the cushioning regions. In some instances, a perimeter flange is provided, spaced apart from the perimeter of the pad.

The combination of the cushioning regions, channels, and flange, as well as the materials from which the pads are formed, together provide various functional characteristics to the pad. For example, the channels are configured to provide unrestricted, free range of motion in critical areas, such as around joints. It should be understood that the channels function as “hinges,” providing the pad with multilevel hinging.

The present pads can be incorporated into clothing, and can be designed to have specific functional characteristics. Such clothing is unique in its ability to provide mobile protection to areas of the body that flex, particularly joints. The padding can be incorporated into garments in a unique way, such that garment materials fit snugly, but stretch and conform to the body, or to a specific joint shape, resulting in a pad that protects the wearer from impact better than other products, because the pad is in constant contact with the wearer during the full range of motion. Garments incorporating the present pads provide improved thermal and impact protection from injury when worn, because of the shape, size, and configuration of the pad, or the material from which the pad is produced. The flexibility of the pad allows the pad to conform to a wearer, so that the pad can be maintained in contact with the wearer. That is, without the degree of flexibility of the present pads, the pads would not be capable of conforming to the changing body contours of the wearer, while in motion. For ease of discussion, the term “flexible,” as used herein, means the ability of the pad to move by bending, twisting, flexing and/or stretching, and the like.

By combining specific shapes, sizes, configurations, contours and orientations of the cushioning regions, channels, and/or a perimeter flange, with specific materials, the pad can be designed to maximize a range of motion of the wearer, while protecting specific, targeted areas of the wearer, particularly joints.

Similarly, the present pad can be incorporated into other items, such as a protective pad assembly. For example, the pad can be incorporated into or provided with a piece of flexible material (e.g. a band or sleeve) that corresponds to the shape and size of the wearer, such that the piece of flexible material fits snugly, but also stretch and conform to the wearer. The construction of the present pad are rugged, durable, and able to withstand the temperatures and mechanical action used in firefighting and other harsh conditions.

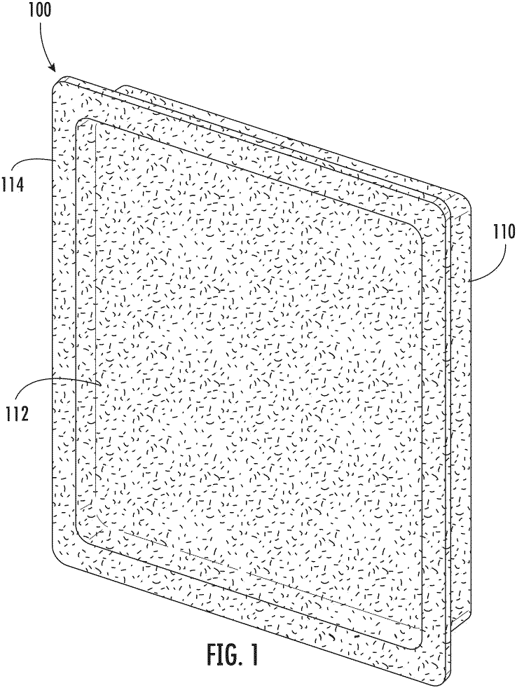

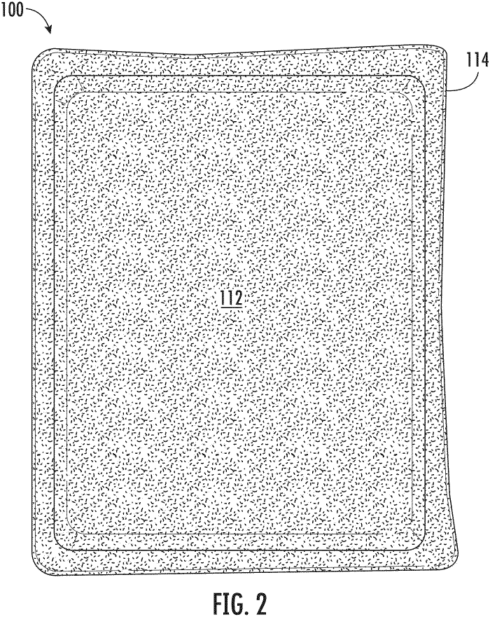

FIGS. 1-3, when taken together, illustrate one exemplary pad 100 according to the present disclosure. The pad 100 may be generally flat. However, it should be appreciated that the shape and a size of the pad 10 may be optimized to contours of a human joint (e.g. elbow, knee, shoulder, etc.) allowing for more articulation and a wider range of motion when the user performs firefighter activities.

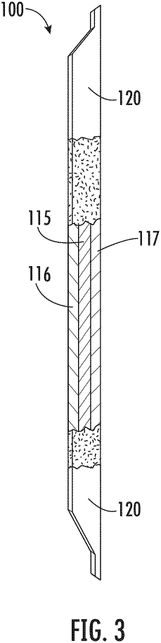

The pad 100 has a shape, size and configuration adapted to the contours of a human joint, as noted above, but it should be understood that the pad can comprise any shape, size or configuration as is practical or desired for a particular design or application. As shown, the pad 100 comprises a front surface 110, a back surface 112 and a peripheral flange 114. As shown in cross-section in FIG. 3, the pad 100 comprises a cushioning layer 115 disposed between outer and inner layers 116, 117.

The outer layer 116 may comprise any material capable of thermal and impact protection; providing sufficient elasticity, flexibility, and durability to prevent tearing and/or stretching when a force is applied thereto; and that is capable of withstanding the environment in which it is intended to be used (e.g., exposure to high temperatures, repetitive deformations such as twisting, bending, flexing, stretching, and the like), without substantial degradation.

The outer layer 116 may comprise any thickness, and the thickness may be varied depending upon the application. In instances in which the comfort and/or breathability of the pad 100 is important, it has been found desirable to minimize the thickness of the outer layer 116. Therefore, in such pads 100, it can be desirable to use the thinnest outer layer 116 possible without sacrificing durability. In other instances, it can be desirable to use a thicker outer layer 116, which may provide increased durability in comparison to thinner outer layers 116. For example, when the present materials are used in high-thermal and/or high-impact applications.

Suitable materials for the outer layer 116 include a variety of synthetic and/or non-synthetic materials including, but not limited to, paper, fabric, metal, metallized plastic, plastic film, metal foil, and/or the like, as well as composites and/or combinations comprising at least one of the foregoing. Other durable materials can be used for the outer layer 116 including knit, woven and nonwoven fabrics (e.g. stretch wovens), leather, vinyl or any other suitable material. Use of a fabric layer as outer layer 116 can be advantageous because it conform to the cushioning layer 115. It may be desirable to use materials for the outer layer 116 that are semi-elastic; therefore, stretchy fabrics, such as spandex fabrics, can be desirable. The use of stretch fabric as the outer layer 116 may be desirable because it can improve the flexing of the hinges, and the forming of the outer layer 116 into a contoured shape.

Other possible materials for the outer layer 116, depending on the application, include heat and flame resistant materials, plastics, elastomeric materials such as rubber, thermoplastic elastomers (“TPE”), and/or the like, and combinations comprising at least one of the foregoing materials. Examples of plastics that can be used for the outer layer include, but are not limited to, ethylene-vinyl acetate (“EVA”), nylon, polyester, polyethylene, polyolefin, polyurethane, polyvinyl chloride (“PVC”), polystyrenes, polytetrafluoroethylene (“PTFE”), latex rubber, silicone, vinyl, and combinations thereof.

In the exemplary embodiment shown in FIG. 3, a least a portion of the outer layer 116 may further include a surface treatment to enhance durability, abrasion resistance, and/or increase friction between the pad 100 and a contact surface such as a coating 120 deposited thereon. The surface treatment, for example the coating 120, may also be provide a water repellant finish to minimize liquid moisture absorption into the pad 100. Such a durable, water repellant finish is provided by treating at least a portion of the outer layer 116 with a 6-carbon based fluorocarbon (C6) material, a 8-carbon based fluorocarbon (C8) material, and/or a commercially available perfluorohydrocarbon material such as TEFLON® (a trademark of E. I. DuPont de Nemours & Co., Inc.) and/or SCOTCHGUARD® (a trademark of Minnesota Mining & Manufacturing Co.), and the like, or a combination thereof, for example.

For example, at least a portion of the outer layer 116 may be coated with a chlorosulfonated polyethylene material. The coating 120 may be deposited on the outer layer 116 prior to forming the pad 100. In other instances, the coating 120 may be deposited on the outer layer 116 prior to forming the pad 100, but is not cured until the outer and inner layers 116, 117 are attached to the cushioning layer 115 during a forming process of the pad 100. Once the inner and outer layers 116, 117 are attached to the cushioning layer 115, and/or the coating 120 is cured, if desired, a trim piece may be coupled to the flange 114. It is understood that the trim piece coupled to the flange 114 may be produced from any suitable material such as a heat and flame resistant fabric, for example.

The inner layer 117 may comprise the same materials as the outer layer 116. When the inner layer 117 comprises a fabric, the fabric may be knit, woven (e.g. stretch woven), non-woven, synthetic, non-synthetic, and combinations comprising at least one of the foregoing. In certain embodiments, the inner layer 117 may be produced from a heat and flame resistant material. When the pad 100 requires stretch, use of the inner layer 117 may be produced from an elastic and/or flexible material. Use of a fabric layer as the inner layer 117 can be advantageous because it conform to the cushioning layer 115. It may be desirable to use materials for the inner layer 117 that are semi-elastic; therefore, stretchy fabrics, such as spandex fabrics, can be desirable. The use of stretch fabric as the inner layer 117 may be desirable because it can improve the flexing of the hinges, and the forming of the inner layer 117 into a contoured shape.

With continued reference to FIGS. 1-3, the cushioning layer 115 of the pad 100 comprises least one cushioning region. In the present exemplary embodiment, pad 100 comprises a single cushioning region 118. The cushioning layer 115 may comprise one or more layers of any material or combination of materials having sufficient structural integrity to be formed into predetermined shapes, such as by molding, and that are capable of withstanding the environment in which they are intended to be used (e.g., exposure to high temperatures, repetitive deformations such as twisting, bending, flexing, stretching, and the like), without substantial degradation. For example, the cushioning layer 115 may be molded to have a substantially planar shape or with articulation (pre-bent) to conform to shape of the wearer.

The material type and composition can be selected to provide articles and/or regions of articles with predetermined material characteristics, which can be used to customize the pad 100 for specific applications such as cushioning, impact resistance, wear resistance, and the like. Preferably, it may be desirable for the pad 100 to have cushioning characteristics to provide a soft, pliable and comfortable feel such as when used in contact with the wearer yet provide sufficient thermal and impact protection when force is applied. In some embodiments, it has been found that non-newtonian materials may be preferable for the cushioning layer 115. In some instances, it may be desirable for the pad 100 to be lightweight and impact resistant, and in such instances, the cushioning layer 115 may comprise a non-newtonian foam material. It should be appreciated that the cushioning layer 115 may have any suitable thickness as desired.

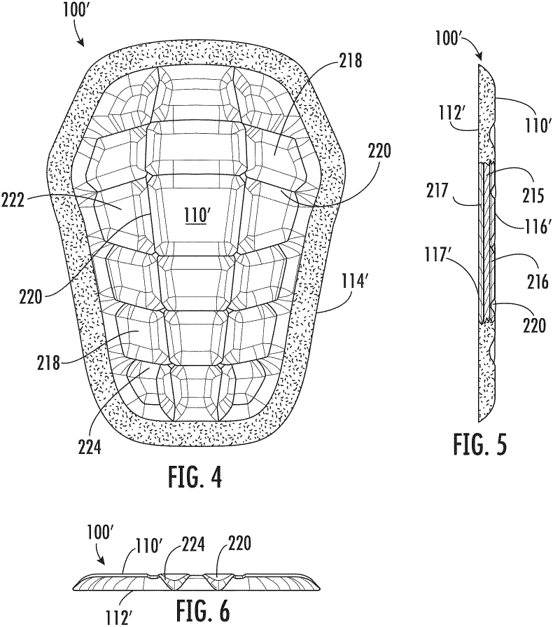

FIGS. 4-6 illustrate a pad 100' according to another embodiment of the present disclosure. Same or substantially similar structure to that described above for FIGS. 1-3 are repeated herein with respect to FIGS. 4-6 includes the same reference numeral and a prime (') symbol.

The pad 100' has a shape, size and configuration adapted to the contours of a knee joint, as noted above, but it should be understood that the pad can comprise any shape, size or configuration as is practical or desired for a particular design or application. As shown, the pad 100' comprises a front surface 110', a back surface 112' and a perimeter 114'. As shown in cross-section in FIG. 5, the pad 100' comprises a cushioning layer 215 disposed between protective layers 216, 217, which are then disposed between outer and inner layers 116', 117'. The protective layers 216, 217 may be produced from any suitable material or combination of materials, such as a membrane or a film, for example. It is understood that the protective layers 216, 217 may be produced from any suitable material capable of preventing the cushioning layer 215 from immersing into the outer and inner layers 116', 117' during a forming process of the pad 100' such as a urethane material, for example. In some instances, however, the pad 100' may be formed without the protective layers 216, 217, if desired. For simplicity, the description for the outer and inner layers 116', 117' is as above and not repeated.

The cushioning layer 215 of the pad 100' may comprise one or more layers of any material or combination of materials having sufficient structural integrity to be formed into predetermined shapes, such as by molding, and that are capable of withstanding the environment in which they are intended to be used (e.g., exposure to high temperatures, repetitive deformations such as twisting, bending, flexing, stretching, and the like), without substantial degradation. For example, the cushioning layer 215 may be molded to have a substantially planar shape or with articulation (pre-bent) to conform to shape of the wearer.

The material type and composition can be selected to provide articles and/or regions of articles with predetermined material characteristics, which can be used to customize the pad 100' for specific applications such as cushioning, impact resistance, wear resistance, and the like. Preferably, it may be desirable for the pad 100' to have cushioning characteristics to provide a soft, pliable and comfortable feel such as when used in contact with the wearer yet provide sufficient thermal and impact protection when force is applied. In some embodiments, it has been found that non-newtonian materials may be preferable for the cushioning layer 215. In some instances, it may be desirable for the pad 100' to be lightweight and impact resistant, and in such instances, the cushioning layer 215 may comprise a non-newtonian foam material. It should be appreciated that the cushioning layer 215 may have any suitable thickness as desired.

In the present exemplary embodiment, pad 100' comprises a plurality of cushioning regions 218 separated by one or more channels 220. Each of the cushioning regions 218 illustrated has a generally polygonal shape. As shown best in FIG. 4, each of the foregoing cushioning regions 218 comprises an upper surface 222 and a sidewall 224 extending downwardly from the upper surface 222. The upper surfaces 222 of the cushioning regions 218 may be contoured using a variety of geometries, including planar surfaces, curved surfaces, and combinations of planar and curved surfaces The sidewalls 224 may be perpendicular to the upper surface 222, or have an angled profile relative to the upper surface 222, coming to a point at a bottom of the channel 220 or hinge. Thus, the channels 220 or hinges may have a saw-tooth shape or have angled walls in some embodiments, which minimizes an exposure of the hinges.

The size, shape, configuration, thickness and material composition of each of the cushioning regions 218 may be varied, depending on a number of factors including, but not limited to, desired amount of flexibility for the pad 100'. With continued reference to FIGS. 4-6, the channels 220 are defined in the upper surface 110' to maintain the cushioning regions 218 in spaced apart relation. For purposes of discussion, the channels 220 may also be referred to hereinafter as hinges throughout the description. A width of the hinges may be varied as desired or needed, and may range from as narrow to broad. In some instances, it may be desirable for the width of the hinges to be as narrow as possible, in order to maximize the protective features of the cushioning regions 218, while maintaining the hinging ability of the pad 100'. Such applications would include applications in which maximum protection is desired, or in which the hinge is intended to wrap around a corner. Where impact protection is desired, the width of the hinges may be designed to be narrower than a width of an object which would impact the pad 100'. In other instances, in which the protective features are less important, it may be desirable for the width of the hinges to be much wider, in order to maximize the comfort and flexibility of the hinges.

The hinges may comprise the generally channels 220 that are disposed along parallel and/or intersecting axes, as best seen in FIG. 4. A depth of the hinges between the cushioning regions 218 may be the same or different, and the depth may vary along the hinge. It should be appreciated that the hinges may have any size, shape, and configuration as desired.

As illustrated, the pad 100' may further include an optional perimeter flange 114'. The flange 114' may be defined in the front surface 110' to maintain the cushioning regions 218 in spaced apart relation from a peripheral edge of the pad 100'. In the present embodiment, the flange 114' has a width of about .625 inches. The width of the flange 114' may vary, as desired. A thickness of the flange 114' is less than the cushioning regions 218, allowing the pad 100' to be attached to items such as garments along the flange 114' using a variety of techniques, such as by sewing, gluing, bonding, and the like.

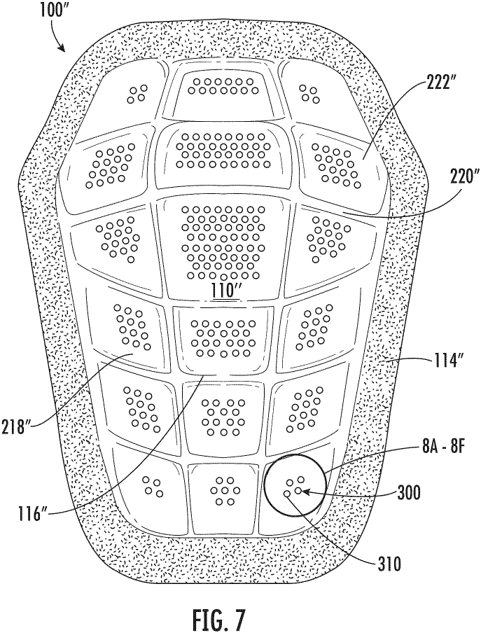

Same or substantially similar structure to that described above for FIGS. 1-6 are repeated in FIG. 7 with the same reference numeral and a double prime (") symbol. In another embodiment of the pad 100" shown in FIG. 7, the outer layer 116", and more preferably the upper surface 222" of one or more of the cushioning regions 218", may further include a surface treatment 300 to enhance durability, abrasion resistance of the pad 100", and/or increase friction between the pad 100" and a contact surface.

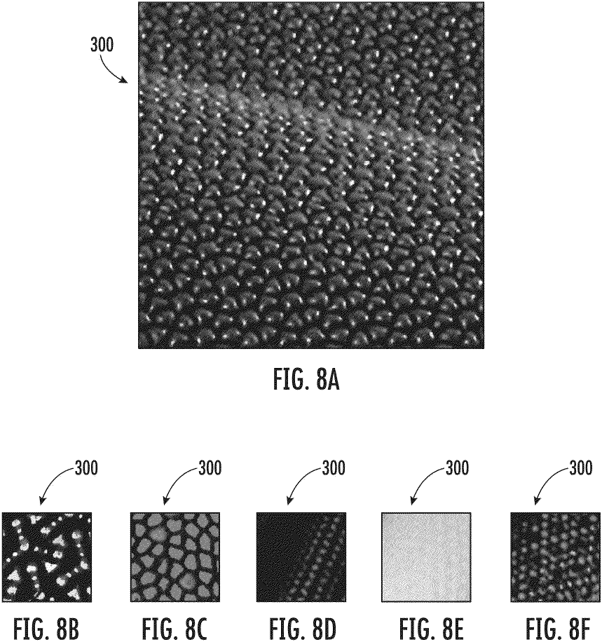

As illustrated, the surface treatment 300 comprises one or more surface irregularities 310 provided on the upper surface 222". Various types, sizes, shapes, numbers, and configurations of the surface irregularities 310, such as those shown in FIGS. 8A-8F, may be employed. It should be appreciated that the surface treatment 300 provided on the cushioning regions 218" may be an alternative to the coating 120 deposited on the outer layer 116 or in addition thereto. In some embodiments, the surface treatment 300 may be provided on the outer layer 116" prior to a forming of the pad 100". However, in other embodiments, the surface treatment 300 may be provided on the outer layer 116" after the pad 100" is formed. The surface treatment 300 may use any durable, heat and flame resistant material as desired.

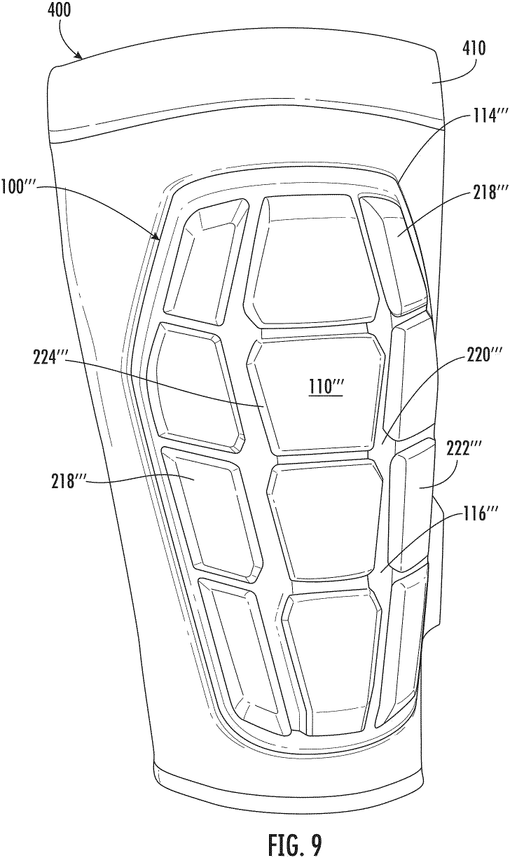

FIG. 9 illustrates a pad assembly 400 including a pad 100''' according to another embodiment of the present disclosure. Same or substantially similar structure to that described above for FIGS. 1-8 are repeated herein with respect to FIG. 9 with the same reference numeral and a triple prime ("') symbol. The pad 100"' is shown with a less number of cushioning regions 218"' and channels 220"'. When integrated with at least one piece of flexible material 410, the pads 100, 100', 100", 100"' may be sewn, glued or otherwise attached to ends of the flexible material 410 or an outside thereof, and in some instances utilizing the flange 114, 114', 114", 114"'; inserted into a pocket provided on the flexible material 410; or it can be sewn or attached to an interior surface of the flexible material 410 and exposed through a corresponding opening in the flexible material 410. It is understood that other methods of attachment may be used, but it has been found that sewing provides certain advantages. In contrast to heat sealing or welding, it has been found that sewing the pads 100, 100', 100", 100"' in place along the flange 114, 114', 114", 114"' prevents or minimizes the pads 100, 100', 100", 100"' from separating from the garment, or flexible material 410. It should be appreciated that the flexible material 410 may be formed form any suitable elastic material as desired.

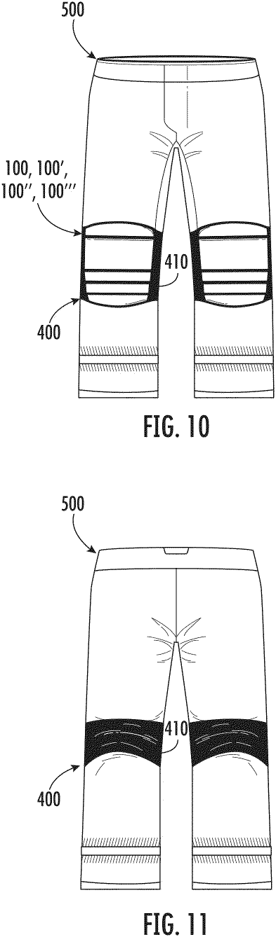

As illustrated in FIGS. 10 and 11, the pads 100, 100', 100", 100"' and/or the pad assembly 400 may be employed with one or more protective garments 500. The protective garment 500 may include an abrasion-, heat-, and flame-resistant outer shell, which covers substantially the entire outer surface of the protective garment 500. More preferably, the pads 100, 100', 100", 100"' and/or the pad assembly 400 may be utilized as kneepads for firefighter turnout pants and/or elbow pads for firefighter turnout coats. For example, the protective garment 500 may include a pair of the pads 100, 100', 100", 100"' sewn to the outer surface of the outer shell layer, which generally follows the periphery of the pads 100, 100', 100", 100"' or it can be sewn or attached to an interior surface of the protective garment 500 and exposed through a corresponding opening formed therein. It should be understood that the pads 100, 100', 100", 100"' may be attached to the outer shell layer by other commonly practiced means, such as adhesives, strips of hook-and-loop fastening material, inserting them into pockets, slide fasteners, and the like. It is also within the scope of the present disclosure to employ the pads 100, 100', 100", 100"' and/or the pad assembly 400 to other areas of the protective garment 500 or other protective garments 500 requiring additional thermal, abrasion and/or impact protection.

The size, shape, configuration, orientation and dimensions of the pads 100, 100', 100", 100"', may be varied as desired in order to achieve the desired characteristics for the design. All of the foregoing features, alone or in combination, are designed to facilitate the thermal and impact protection as well as flexibility of the pads 100, 100', 100", 100"' either inwardly or outwardly to conform to a wearer during movement. However, it should be understood that in each of the foregoing embodiments, and in any of the pads 100, 100', 100", 100"' according to the present disclosure, all of the foregoing measurements can vary depending on the desired characteristics and design of the pads 100, 100', 100", 100"'. For example, the pads 100, 100', 100", 100"' are designed to provide a variety of characteristics such as, but not limited to, cushioning, vibration dampening and/or impact absorption, and the like. The characteristics of the pads 100, 100', 100", 100"' may be varied by changing the thickness and/or material types of cushioning layers 115, 115', changing the spacing between the cushioning regions 218, 218", 218"' (i.e., the width of the hinges), and/or changing the contours of the cushioning regions 218, 218", 218"', and the like.

In each of the foregoing embodiments, and in any of the pads 100, 100', 100", 100"' according to the present disclosure, the channels 220, 220", 220"' are designed provide flexibility to the pads 100, 100', 100", 100''' in targeted areas in which flexibility is desired or needed. Using curved, parallel and/or intersecting channels 220, 220", 220"' allows the flexibility of the pads 100, 100', 100", 100"' to be tailored to specific functions, such as protecting joints during motion. The width, depth, orientation and position of the channels 220, 220", 220"' may vary, depending on a number of factors including, but not limited to, the desired amount and location of flexibility for the pads 100, 100', 100", 100"'.

The flexibility of the channels 220, 220", 220"' can be varied, by varying the thickness of the material in the channels 220, 220", 220"'. For example, decreasing the thickness of the material in the channels 220, 220", 220"' increases the flexibility of the pads 100, 100', 100", 100"', and increasing the thickness of the material in the channels 220, 220", 220"' decreases the flexibility.

The present pads 100, 100', 100'', 100"' and methods of manufacture are advantageous for many reasons. For example, single continuous pads 100, 100', 100", 100"' with many elements provides an economic advantage over traditional pad construction techniques, by eliminating labor-intensive cutting, scoring or thermoforming that may otherwise be required for end garment construction. The present pads 100, 100', 100", 100"' can be manufactured to provide better thermal and impact protection to specific body areas while being lightweight, which is a significant advantage to firefighters and active individuals. Advantageously, the pads 100, 100', 100", 100"' are less bulky than conventional pads, allowing a greater range of motion and quickly donning and doffing of firefighter’s pant around the boots.

In addition, the continuous bonding of the inner and outer layers 116, 116', 116'', 116"', 117, 117', 117", 117"' either to the cushioning layer 115, 115', 115", 115"' or to each other, prevents or minimizes a risk of fluid or other materials from getting into the pads 100, 100', 100", 100"'.

The aforementioned features enhance the thermal and impact protection along with durability of the pads 100, 100', 100", 100"' in hazardous conditions, eliminating or preventing completely the delamination of layers, as occurs in other products. Such pads 100, 100', 100", 100"' are compliant with any and all associated National Fire Protection Association (NFPA) 1971, 1977, 1999, and 1951 standards and associated military standards.

From the foregoing description, one ordinarily skilled in the art can easily ascertain the essential characteristics of this subject matter of the present disclosure and, without departing from the spirit and scope thereof, can make various changes and modifications to the subject matter of the pressure disclosure to adapt it to various usages and conditions.

What is claimed is:

1. A pad, comprising:
a first layer produced from a heat and flame resistant material;
a second layer disposed on the first layer, wherein the second layer is produced from a non-newtonian material.

2. The pad of claim 1, wherein the heat and flame resistant material of the first layer is a fabric material.

3. The pad of claim 1, wherein the non-newtonian material is a foam material.

4. The pad of claim 1, wherein the second layer includes one or more cushioning regions formed by at least one channel.

5. The pad of claim 1, further comprising a third layer produced from a heat and flame resistant material.

6. The pad of claim 1, further comprising a flange provided around a peripheral edge of the pad.

7. The pad of claim 1, wherein the first layer includes a surface treatment for increasing a durability, abrasion resistance, and/or friction of the pad.

8. The pad of claim 7, wherein the surface treatment is a coating deposited on the first layer.

9. The pad of claim 8, wherein the coating is a chlorosulfonated polyethylene material.

10. The pad of claim 7, wherein the surface treatment is one or more surface irregularities formed on a surface of the first layer.

11. The pad of claim 10, wherein the one or more surface irregularities is produced from a durable, heat and flame resistant material.

12. A pad assembly, comprising:
a piece of flexible material; and
a pad coupled to the piece of flexible material, wherein the pad comprises a first layer and a second layer disposed on the first layer, wherein the second layer is produced from a non-newtonian material.

13. The pad assembly of claim 12, wherein the pad further comprises a third layer coupled to the second layer.

14. The pad assembly of claim 13, wherein at least one of the first layer and the third layer is produced from a heat and flame resistant material.

15. The pad assembly of claim 13, wherein the pad further comprises at least one protective layer disposed between the second layer and at least one of the first layer and the third layer.

16. A method of producing a pad for firefighting equipment, comprising the steps of:
providing a first layer of a heat and flame resistant material;
providing a second layer of non-newtonian foam material; and
coupling the second layer to the first layer.

17. The method of claim 16, further comprising providing a third layer produced from a heat and flame resistant material.

18. The method of claim 17, further comprising coupling the third layer to the second layer to form the pad.

19. The method of claim 16, further comprising applying a coating to the first layer.

20. The method of claim 19, wherein the coating is uncured until the second layer is coupled to the first layer.
